(19) United States
(12) Patent Application Publication
(10) Pub. No.: US 2026/0254076 A1
(43) Pub. Date: Aug. 27, 2026

(54) SECONDARY BATTERY AND METHOD OF MANUFACTURING SECONDARY BATTERY

(71) Applicant: SAMSUNG SDI CO., LTD., Yongin-si (KR)

(72) Inventor: Dong Bok YANG, Yongin-si (KR)

(21) Appl. No.: 19/448,741

(22) Filed: Jan. 14, 2026

(30) Foreign Application Priority Data
Feb. 21, 2025 (KR) 10-2025-0022646

(51) Int. Cl. H01M 50/645; H01M 10/052; H01M 50/103; H01M 50/119; H01M 50/15; H01M 50/159

(52) U.S. Cl. CPC H01M 50/645; H01M 10/052; H01M 50/103; H01M 50/119; H01M 50/15; H01M 50/159

(57) ABSTRACT

A secondary battery may include an electrode assembly including a first electrode, a separator, and a second electrode; a case including one open surface accommodating the electrode assembly and an electrolyte injection port on one side of the case; a cover coupled to the one open surface of the case; and a stopper including a resin material on an outer circumferential surface of the stopper, the stopper configured to seal the electrolyte injection port.

### CROSS-REFERENCE TO RELATED APPLICATION

This application claims priority under 35 U.S.C. §119 to Korean Patent Application No. 10-2025-0022646, filed in the Korean Intellectual Property Office on February 21, 2025, the entire contents of which are hereby incorporated by reference.

### BACKGROUND

### Field

The present disclosure relates to a secondary battery and a method of manufacturing a secondary battery.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and are widely used for storing power (e.g., home and/or utility scale power storage). A secondary battery generally includes an electrode assembly composed of a positive electrode and a negative electrode, a case accommodating the same, and electrode terminals connected to the electrode assembly.

The secondary battery case used in a small-sized electronic device is formed of a metallic material such as aluminum alloy, but damage to the secondary battery may occur for various reasons during various processes.

After an electrolyte is injected into the inside of a secondary battery, a sealer is coupled to an electrolyte injection port and is welded by a laser to seal an inner space. When a sealer is welded to an electrolyte injection port by using the laser and when the laser beam is aligned with an electrode plate and a separator of an electrode assembly and penetrates the inside of the secondary battery during welding, ignition accidents may occur due to damage to the electrode and/or the separator.

The above information disclosed in this Background section is for the enhancement of understanding of the background of the present disclosure, and, therefore, it may contain information that does not constitute related (or prior) art.

### SUMMARY

The present disclosure is aimed at providing a secondary battery and a method of manufacturing the secondary battery for solving the above-described problems.

However, the technical problem to be solved by the present disclosure is not limited to the above problem, and other problems not mentioned herein, and aspects and features of the present disclosure that would address such problems, will be clearly understood by those skilled in the art from the description, drawings, and/or claims of the present disclosure.

A secondary battery according to some embodiments of the present disclosure may include an electrode assembly including a first electrode, a separator, and a second electrode; a case including one open surface configured to accommodate the electrode assembly and an electrolyte injection port on one side of the case; a cover coupled to the one open surface of the case; and a stopper including a resin material on an outer circumferential surface of the stopper, the stopper configured to seal the electrolyte injection port.

In some embodiments, the stopper may include a stopper body; and a stopper resin coated on an outer circumferential surface of the stopper body.

In some embodiments, the stopper may be placed in the electrolyte injection port, and the stopper resin may be in contact with an inner circumferential surface of the electrolyte injection port.

In some embodiments, the case and the cover may be formed of a same metallic material.

In some embodiments, the same metallic material of the case and the cover may include stainless use steel.

In some embodiments, a thickness of the case ranges from about 50 μm to about 100 μm.

In some embodiments, a thickness of the stopper body may be less than a thickness of the case.

In some embodiments, the stopper body may be formed in one of a circular, a polygonal, or a trapezoidal shape from a planar view.

In some embodiments, the stopper body may have a spherical shape.

In some embodiments, the stopper body may include at least one of stainless steel, aluminum, nickel, or iron.

In some embodiments, the stopper resin may be a thermoplastic resin or a thermosetting resin.

In some embodiments, the stopper resin may include at least one of polyimide, polyethylene terephthalate, polypropylene, polyethylene, polystyrene, acrylonitrile butadiene styrene copolymer, polyoxymethylene, polyvinyl chloride, polycarbonate, nylon, polycaprolactone, polylacticacid, acrylic resin, polyester, polybutylene terephthalate, celluloid, teflon, bakelite, epoxy, melamin, urea, and phenol.

In some embodiments, the stopper resin may be coated on the outer circumferential surface of the stopper body, the stopper body having a thickness ranging from about 1 μm to about 10 μm.

In some embodiments, the secondary battery further may include a protective layer. The stopper may be placed in the electrolyte injection port. The protective layer may be configured to cover the electrolyte injection port.

Some embodiments of the present disclosure may include method of manufacturing a secondary battery. The method may include inserting an electrode assembly into one open surface of a case, the case having an electrolyte injection port on one side of the case; attaching a cover onto the one open surface of the case; injecting an electrolyte into the case through the electrolyte injection port; and placing a stopper including a resin material onto an outer circumferential surface of the electrolyte injection port.

In some embodiments, the method further may include providing the stopper such that the stopper may include a stopper body, and a stopper resin coated on an outer circumferential surface of the stopper body.

In some embodiments, the method further may include press-fitting the stopper into the electrolyte injection port by pressing one surface of the stopper. The stopper resin may be placed in contact with an inner circumferential surface of the electrolyte injection port.

In some embodiments, the method further may include providing the case such that a thickness of the case ranges from about 50 μm to about 100 μm.

In some embodiments, the method further may include providing the case and the cover such that the case and the cover may be formed of a same metallic material, and the same metallic material may include stainless use steel.

In some embodiments, the method further may include forming, after press-fitting the stopper into the electrolyte injection port, a protective layer that covers the electrolyte injection port.

According to some embodiments of the present disclosure, an inside of the secondary battery may be sealed by a stopper that seals an electrolyte injection port with a resin material on an outer circumferential surface. Accordingly, a secondary battery may be sealed without using a laser, and, as a result, damage to the electrode and/or the separator inside the secondary battery may be less likely, reducing ignition accidents. Therefore, safety of the secondary battery may be improved.

According to some embodiments of the present disclosure, there is further provided a protective layer that covers an electrolyte injection port where a stopper is placed to improve bonding stability of the stopper bonded by using a press-fitting method.

However, aspects and features of the present disclosure are not limited to those described above, and other aspects and features not mentioned will be clearly understood by a person skilled in the art from the detailed description, drawings, and/or claims of the present disclosure.

### BRIEF DESCRIPTION OF DRAWINGS

The following drawings attached to this specification illustrate embodiments of the present disclosure, and further describe aspects and features of the present disclosure together with the detailed description of the present disclosure. The present disclosure should not be construed as being limited to the drawings.

FIG. 1 is an exploded perspective view illustrating a secondary battery according to some embodiments of the present disclosure.

FIG. 2 is a perspective view illustrating a secondary battery according to some embodiments of the present disclosure.

FIG. 3 is a planar view illustrating a secondary battery according to some embodiments of the present disclosure.

FIG. 4 is a cross-sectional view illustrating a comparative example of a secondary battery according to some embodiments of the present disclosure.

FIG. 5 is a cross-sectional view taken along line A-A’ of FIG. 3 when a stopper is press-fitted according to some embodiments of the present disclosure.

FIG. 6 is a cross-sectional view taken along line A-A’ of FIG. 3 when a stopper is press-fitted according to some embodiments of the present disclosure.

FIG. 7 is a cross-sectional view taken along line A-A’ of FIG. 3 when a stopper is press-fitted according to some embodiments of the present disclosure.

FIG. 8 is a perspective view illustrating a secondary battery, showing a direction in which a stopper is injected into an electrolyte injection port, and showing a pressing direction according to some embodiments of the present disclosure.

FIG. 9 is a view illustrating various stoppers according to some embodiments of the present disclosure.

FIG. 10 is a view illustrating various stoppers from a planar perspective according to some embodiments of the present disclosure.

FIG. 11 is a cross-sectional view illustrating a secondary battery including a protective layer according to some embodiments of the present disclosure.

FIG. 12 is a flow chart illustrating a manufacturing process of a secondary battery according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure based on the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, the dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.”

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

In this specification, singular expressions include plural expressions unless the context clearly specifies singular expressions. In addition, plural expressions include singular expressions unless the context clearly specifies plural expressions. Throughout the specification, when a part is described as including a component, it implies that additional components may also be included unless specifically stated to the contrary.

According to some embodiments of the present disclosure, the sizes of layers and areas are illustrated in the drawings may be exaggerated for clarity of explanation. The sizes in the drawings are only for ease of explanation, but the present disclosure is not limited thereto. Like reference numerals in the drawings denote like elements throughout the specification.

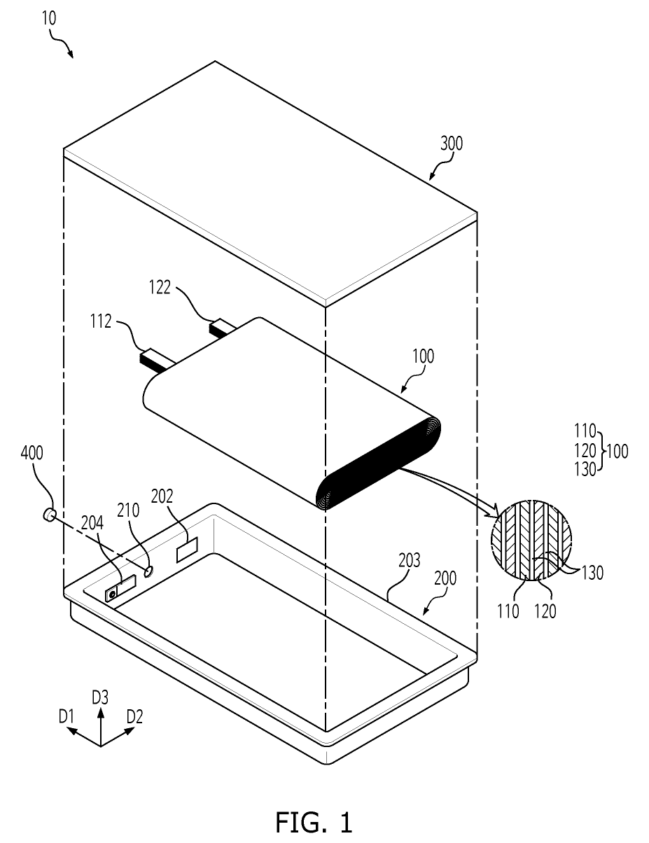

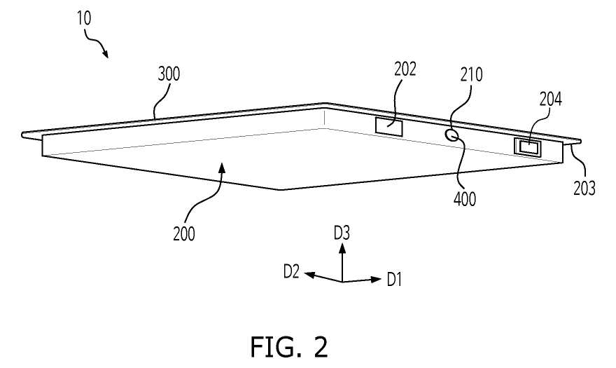

FIG. 1 is an exploded perspective view illustrating a secondary battery according to some embodiments of the present disclosure. FIG. 2 is a perspective view illustrating a secondary battery according to some embodiments of the present disclosure.

Referring to FIG. 1 and FIG. 2, a secondary battery 10 may include an electrode assembly 100, a case 200 including an accommodating space for accommodating the electrode assembly 100, a cover 300 coupled to the case 200, and a stopper 400 that seals an electrolyte injection port 210 formed in the case 200. According to some embodiments of the present disclosure, the stopper 400 may include a resin material on an outer circumferential surface to seal the electrolyte injection port 210. Accordingly, the damage to the electrode and/or the separator inside the secondary battery, which occurs during laser welding and sealing at the periphery of the electrolyte injection port may be prevented.

The electrode assembly 100 may include a first electrode 110, a separator 130, and a second electrode 120. The electrode assembly 100 may be formed by winding or stacking the separator 130, which is an insulator, between the first electrode 110 and the second electrode 120. The first electrode 110 may include a first substrate and a first active material layer disposed on the first substrate. A first electrode tab 112 may extend outward from a first non-coated part of the first substrate where the first active material layer is not arranged.

The second electrode 120 may include a second substrate and a second active material layer disposed on the second substrate. A second electrode tab 122 may extend outward from a second non-coated part where a second active material layer is not arranged on the second substrate.

The first electrode 110 may function as a positive electrode. The first substrate may be a positive electrode substrate. The positive electrode substrate may be formed of aluminum foil, and the positive electrode active material may include, for example, a transition metal oxide.

The positive electrode active material may include a compound (litigated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

The following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol%, greater than or equal to about 85 mol%, greater than or equal to about 90 mol%, greater than or equal to about 91 mol%, or greater than or equal to about 94 mol% and less than or equal to about 99 mol%, based on 100 mol% of the metal excluding lithium in the lithium transition metal composite oxide. The high-nickel-based positive electrode active material may be capable of realizing high capacity and can be applied to a high-capacity, high-density rechargeable lithium battery.

The second electrode 120 may function as a negative electrode. The second substrate may be a negative electrode substrate. The negative electrode substrate may be formed of, for example, copper foil or nickel foil, and the negative electrode active material may include, for example, graphite.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon, or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0 < x < 2), a Si-Q alloy (where Q is selected from an alkali metal, an alkaline-earth metal, a Group 13 element, a Group 14 element (excluding Si), a Group 15 element, a Group 16 element, a transition metal, a rare earth element, or a combination thereof). The Sn-based negative electrode active material may include Sn, SnO2, a Sn-based alloy, or a combination thereof.

The silicon-carbon composite may be a composite of silicon and amorphous carbon. According to some embodiments, the silicon-carbon composite may be in the form of silicon particles and amorphous carbon coated on a surface of the silicon particles. The silicon-carbon composite may include a secondary particle (core) in which primary silicon particles are assembled, and an amorphous carbon coating layer (shell) on a surface of the secondary particle. The amorphous carbon may also be between the primary silicon particles, and the primary silicon particles may be coated with the amorphous carbon. The secondary particle may exist dispersed in an amorphous carbon matrix.

The silicon-carbon composite may further include crystalline carbon. In some embodiments, the silicon-carbon composite may include a core including crystalline carbon and silicon particles and an amorphous carbon coating layer on the surface of the core.

The Si-based negative electrode active material or the Sn-based negative electrode active material may be used in combination with a carbon-based negative electrode active material.

The separator 130 may include polyethylene, polypropylene, polyvinylidene fluoride, or a multilayer film of two or more layers thereof, and a mixed multilayer film such as a polyethylene / polypropylene two-layer separator, polyethylene / polypropylene / polyethylene three-layer separator, polypropylene / polyethylene / polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer polyolefin (such as polyethylene and polypropylene), polyester (such as polyethylene terephthalate and polybutylene terephthalate), polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, polytetrafluoroethylene, or a copolymer or mixture of two or more thereof.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, or a combination thereof, but the inorganic material is not limited thereto.

The organic material and the inorganic material may be mixed in one coating layer, or a coating layer including an organic material and a coating layer including an inorganic material may be stacked.

One side (e.g., one side in a D3 direction of the case 200) of the case 200 may be opened for accommodating the electrode assembly 100. One side of the case 200 may be opened and an accommodating space for accommodating the electrode assembly 100 may be formed. The electrode assembly 100 may be inserted into one open side of the case 200 to be accommodated in the accommodating space. The cover 300 may be coupled to one open side of the case 200 to seal the accommodating space.

The case 200 may include a negative electrode terminal 202 and a positive electrode terminal 204 disposed on a side (e.g., one side in a D1 direction of the case 200) different from one open side. The case 200 may include an electrolyte injection port 210. The electrolyte injection port 210 may be formed on one side of the case 200.

The electrolyte injection port 210 may be a through-hole formed on a side of the case 200. The electrolyte injection port 210 may be formed to inject an electrolyte into the inside of the case 200 of the secondary battery 10 after the case 200 and the cover 300 are bonded and sealed. The electrolyte injection port 210 may be sealed by the stopper 400 after the electrolyte is injected. The electrolyte injection port 210 according to some embodiments of the present disclosure is illustrated as being disposed between a pair of electrode terminals, but the electrolyte injection port 210 is not limited thereto and may be disposed at other locations.

A pair of electrode terminals may be placed on the side of the case 200. The negative electrode terminal 202 and the positive electrode terminal 204 may be placed in a D2 direction with respect to the electrolyte injection port 210.

The positive electrode terminal 204 may be electrically connected to the first electrode tab 112 of the electrode assembly 100, and the negative electrode terminal 202 may be electrically connected to the second electrode tab 122 of the electrode assembly 100. However, the positions of the positive electrode terminal 204 and the negative electrode terminal 202 are not limited as shown in FIG. 1 and may be other positions.

An accommodating space for accommodating the electrode assembly 100 may be formed at the center area of the case 200 by a press processing, etc. In some embodiments, a flange 203 may be formed at the upper edge of the accommodating space in four (4) directions.

The cover 300 may be coupled to one open surface of the case 200. According to some embodiments, the case 200 may be bonded to the cover 300 to form an exterior of the secondary battery 10. The cover 300 may be formed of a flat plate arranged on an upper part of the case 200 to seal the accommodating space of the case 200. The cover 300 may be formed of a flat plate large enough to cover the flange 203 such that it has surface contact with the flange 203.

The case 200 and the cover 300 may be bonded by metal bonding (e.g., welding, brazing, soldering, etc.) The flange 203 of the case 200 may be bonded to the edge of the cover 300. After the case 200 is bonded to the cover 300, at least part of the flange 203 may be cut by using laser to increase energy density of the secondary battery 10.

The case 200 is illustrated as including the flange 203 in the drawing, but the present disclosure is not limited thereto. The case 200 may be coupled to the cover 300 without the flange 203.

In some embodiments, the case 200 and the cover 300 may be bonded through a separate adhesive layer. The adhesive layer may include at least one of hot melt, rubber, or acrylic. When the adhesive layer includes a hot melt adhesive, the hot melt adhesive may include, an acrylic resin, a synthetic rubber resin, a polyolefin resin, an ester resin, a urethane resin, an epoxy resin, or a silicone resin, but the hot melt adhesive is not limited thereto. In some embodiments, the film may be impregnated with the hot melt adhesive by applying a molten hot melt adhesive solution to a film layer or by impregnating the film layer with a hot melt adhesive solution dissolved in a solvent and then volatilizing the solvent. However, the film is not limited thereto, and various impregnation methods of the hot melt adhesive may be used.

The method of bonding the case 200 to the cover 300 is not limited to the methods described above, and various methods for bonding two materials may be used at the discretion of those skilled in the art.

At least one of the case 200 and the cover 300 may include stainless use steel (SUS). The case 200 and the cover 300 shown in FIG. 1 may include stainless use steel (SUS), and the secondary battery 10 may be an SUS can-type secondary battery, but the present disclosure is not limited thereto. The case 200 and the cover 300 may be formed of a conductive metal such as aluminum, aluminum alloy, or nickel-plated steel to form the overall exterior of the secondary battery 10.

According to some embodiments, the case 200 and the cover 300 may be formed of a same metallic material. With the same material constituting the case 200 and the cover 300, corrosion may be prevented from occurring at an area where the case 200 and the cover 300 are bonded due to a potential difference between different metals. The metallic material constituting the case 200 and the cover 300 may include stainless steel (stainless use steel, SUS). The stainless-steel material may be determined as any type of stainless-steel series material such as SUS 304, SUS 316, SUS 420, SUS 430, etc. depending on a type and a ratio of the alloy material within the stainless-steel series.

The secondary battery 10 may be a lithium battery cell, a sodium battery cell, etc. However, the present disclosure is not limited thereto, as the secondary battery 10 may include all types of batteries capable of providing electricity repeatedly by charging and discharging. The configuration of the secondary battery as shown in FIG. 1 is only exemplary, and components other than components illustrated in embodiments above may be added or omitted. In some embodiments, the shapes, the positional relationships, etc. of the secondary battery shown in FIG. 1 may vary appropriately.

D1, D2 and D3 shown in FIG. 1 may respectively refer to a length direction, a width direction and a thickness direction of the secondary battery 10 or a component (e.g., the case 200, the electrode assembly 100, etc.) of the secondary battery 10.

The stopper 400 may include a resin material on the outer circumferential surface to seal the electrolyte injection port 210. The stopper 400 may be placed in the electrolyte injection port 210 and may be pressed in the accommodating space to be closely attached to the electrolyte injection port 210. The outer circumferential surface of the stopper 400 may include a resin material having elasticity to be closely attached to the inner circumferential surface of the electrolyte injection port 210 when pressed in the electrolyte injection port 210. Therefore, the stopper 400 may be inserted into the electrolyte injection port 210 after an electrolyte is injected into the inside of the case 200 to seal the secondary battery 10.

External heat may be provided to the stopper 400 being inserted into the electrolyte injection port 210 so that the stopper 400 is closely attached to the electrolyte injection port 210. The outer circumferential surface of the stopper 400 may include thermosetting resin or thermoplastic material, which may be closely attached to the inner circumferential surface of the electrolyte injection port 210 when heat is provided. Therefore, the stopper 400, after an electrolyte is injected into the inside of the case 200, may be injected into the electrolyte injection port 210 to seal the secondary battery 10.

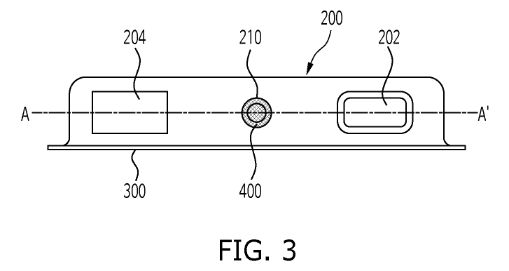

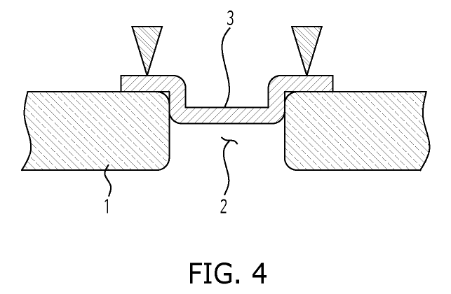

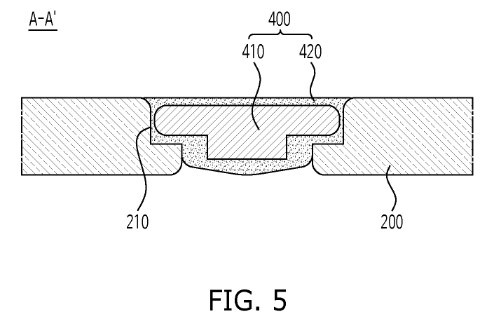

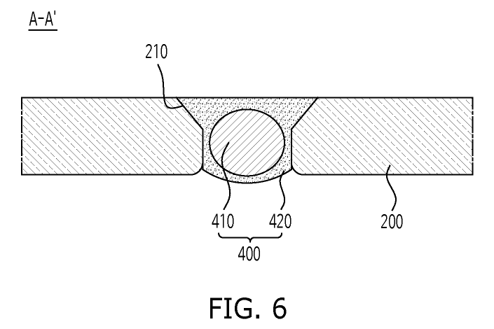

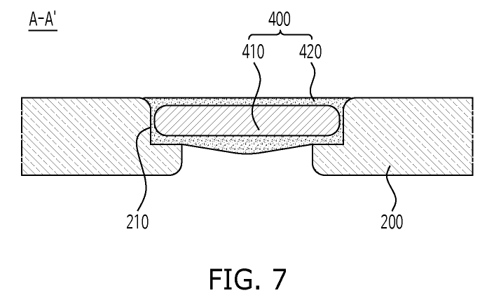

FIG. 3 is a planar view illustrating a secondary battery according to some embodiments of the present disclosure. FIG. 4 is a cross-sectional view illustrating a comparative example of a secondary battery according to some embodiments of the present disclosure. FIG. 5 is a cross-sectional view taken along line A-A’ of FIG. 3 when a stopper is press-fitted according to some embodiments of the present disclosure. FIG. 6 is a cross-sectional view taken along line A-A’ of FIG. 3 when a stopper is press-fitted according to some embodiments of the present disclosure. FIG. 7 is a cross-sectional view taken along line A-A’ of FIG. 3 when a stopper is press-fitted according to some embodiments of the present disclosure.

According to some embodiments, the stopper 400 may include a resin material at the outer circumferential surface to seal the electrolyte injection port 210. The stopper 400 may include a resin material having elasticity, and the resin may be inserted into the electrolyte injection port 210 by pressing upon the resin to seal the electrolyte injection port 210. Accordingly, damage to the electrode and/or the separator inside the secondary battery, which occurs during laser welding and during sealing at the periphery of the electrolyte injection port 210 may be prevented.

The electrolyte injection port 210, when the cover 300 is coupled to the case 200, may be sealed by the stopper 400 after an electrolyte is injected into the inside of the case 200. FIG. 3 illustrates that the electrolyte injection port 210 may be placed between the negative electrode terminal 202 and the positive electrode terminal 204, but the present disclosure is not limited thereto, as placement of the electrolyte injection port 210 may vary.

According to a comparative example in FIG. 4, an electrolyte may be injected into a case 1 through an electrolyte injection port 2 of the case 1 of a secondary battery, and a cap 3 having a shape corresponding to the electrolyte injection port 2 may be placed over the electrolyte injection port 2. The upper peripheral part of the cap 3 may be laser-welded to be coupled to the electrolyte injection port 2 and the secondary battery may be sealed. A problem arises when a position at which the cap 3 is welded to the electrolyte injection port 2 is aligned with positions of an electrode and a separator of an electrode assembly, and, during welding, a flow of a laser beam into the secondary battery may damage the electrode and/or the separator. When the electrode and/or the separator are damaged, ignition accidents may occur during charging of the secondary battery.

According to some embodiments, a stopper 400 may include a stopper body 410 and a stopper resin 420. The stopper resin 420 may be coated on the outer circumferential surface of the stopper body 410. The stopper resin 420 may be coated on the entire outer circumferential surface of the stopper body 410.

The stopper 400 may be placed upon and pressed into the electrolyte injection port 210, and the stopper resin 420 may be in close contact with the inner circumferential surface of the electrolyte injection port 210. When the stopper 400 is placed upon and pressed into the electrolyte injection port 210 formed in the case 200, the stopper 400 may be closely attached to the electrolyte injection port 210 by the resin 420 coated on the outer circumferential surface of the stopper body 410, which prevents any gap between the stopper 400 and the electrolyte injection port 210 and seals the electrolyte injection port 210. Therefore, the electrolyte inside the case 200 may be prevented from leaking through the electrolyte injection port 210.

According to some embodiments, the electrolyte injection port 210 may have a stair-shaped cross-section as shown in FIG. 5. The stopper body 410 may be formed in a pin-shape having a head and an axis. The stopper resin 420 may have a shape corresponding to the outer circumferential surface of the stopper body 410 to be coated on the entire area of the stopper body 410. The stopper resin 420 may be in close contact with the inner circumferential surface of the electrolyte injection port 210 having a stair shape to seal the electrolyte injection port 210.

In some embodiments, as shown in FIG. 6, the electrolyte injection port 210 may be formed into a tapered shape. The stopper body 410 may have a spherical shape. The stopper resin 420 may correspond to an outer circumferential surface shape of the stopper body 410 to be coated on an entire area of the stopper body 410. In some embodiments, the stopper resin 420 may have a shape corresponding to the outer circumferential surface of the stopper body 410 and the tapered shape of the electrolyte injection port 210 to be coated on the stopper body 410. The stopper resin 420 may be in close contact with the inner circumferential surface of the electrolyte injection port 210 in a tapered shape to seal the electrolyte injection port 210.

In some embodiments, the electrolyte injection port 210 may have a stair-shaped cross-section as shown in FIG. 7. The stopper body 410 may have a flat plate shape that takes place over an upper end of the electrolyte injection port 210. The stopper resin 420 may correspond to the outer circumferential surface shape of the stopper body 410 to be coated on the entire area of the stopper body 410. The stopper resin 420 may be in close contact with the upper inner circumferential surface in a stair shape to seal the electrolyte injection port 210.

The stopper body 410 may include at least one of stainless steel (SUS), aluminum (Al), nickel (Ni), or iron (Fe). The stopper body 410 may also include a high-hardness plastic material.

The stopper resin 420 may be a thermoplastic resin or a thermosetting resin. The stopper resin 420 may be a composite material including a thermoplastic resin or a thermosetting resin.

According to some embodiments, the stopper resin 420 may be include at least one of polyimide (PI), polyethylene terephthalate (PET), polypropylene (PP), polyethylene (PE), polystyrene (PS), acrylonitrile butadiene styrene copolymer (ABS), polyoxymethylene (POM), polyvinyl chloride (PVC), polycarbonate (PC), nylon, polycaprolactone (PLC), polylactic acid (PLA), acrylic resin, polyester (PET), polybutylene terephthalate (PBT), celluloid, teflon, bakelite, epoxy, melamine, urea, and phenol.

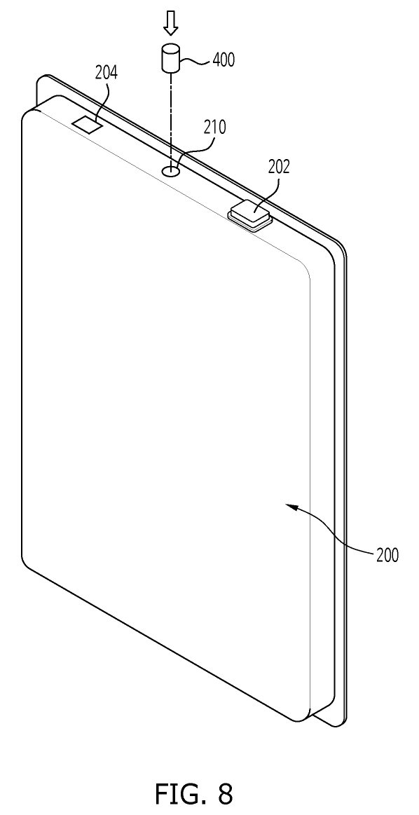

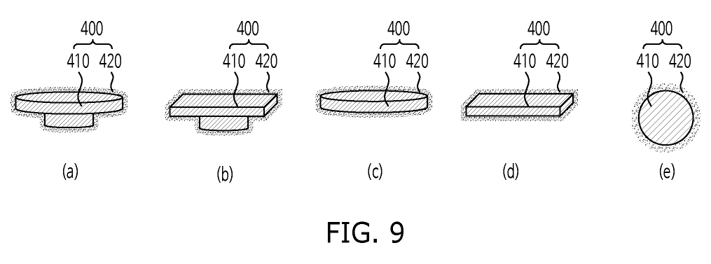

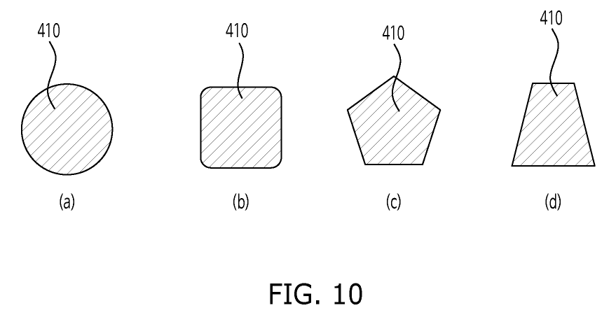

FIG. 8 is a perspective view illustrating a secondary battery, showing a direction in which a stopper is injected into an electrolyte injection port, and showing a pressing direction according to some embodiments of the present disclosure. FIG. 9 is a view illustrating various stoppers according to some embodiments of the present disclosure. FIG. 10 is a view illustrating various stoppers from a planar perspective according to some embodiments of the present disclosure.

The electrolyte injection port 210, when the cover is coupled to the case 200, may be sealed by the stopper 400 after an electrolyte is injected into the inside of the case 200. FIG. 8 illustrates that the electrolyte injection port 210 is placed between the negative electrode terminal 202 and the positive electrode terminal 204, but the electrolyte injection port 210 is not limited thereto and may be positioned at other locations.

In FIG. 8, when the electrolyte injection port 210 is formed on one upper surface of the case 200, the stopper 400 is placed in the electrolyte injection port 210, the upper surface of the stopper 400 may be press-fitted to be pressed in the electrolyte injection port 210. When the stopper 400 is placed in the electrolyte injection port 210, and the upper surface is pressed, the stopper resin 420 may be in close contact with the inner circumferential surface of the case 200 to seal the electrolyte injection port 210.

The shape of the stopper body 410 may correspond to that of the electrolyte injection port 210 in various embodiments. In FIG. 9, example (a), the stopper body 410 may have a pin-shape with a circular head and an axis. The stopper resin 420 may have a shape corresponding to the outer circumferential surface shape of the stopper body 410 to be coated on the entire area of the stopper body 410 in a pin shape. In FIG. 9, example (b), the stopper body 410 may be formed in a pin shape having a diagonal head and an axis. The stopper resin 420 may have a shape corresponding to the outer circumferential surface shape to be coated on the entire area of the stopper body 410 in a pin shape.

As shown in FIG. 9, example (c), the stopper body 410 may be formed in a circular flat plate shape. The stopper resin 420 may be coated on the entire area of the stopper body 410 in a circular flat shape corresponding to the outer circumferential surface shape of the stopper body 410. As shown in FIG. 9, example (d), the stopper body 410 may be formed in a diagonal flat shape. The stopper resin 420 may have a shape corresponding to the outer circumferential surface shape of the stopper body 410 and may be coated on the entire area of the stopper body 410 in a diagonal flat shape.

As shown in FIG. 9, example (e), the stopper body 410 may be formed in a spherical shape. The stopper resin 420 may be coated on the entire area of the stopper body 410 in a spherical shape corresponding to the shape of the outer circumferential surface of the stopper body 410.

The stopper body 410 may be formed in any one of a circle, a polygon, or a trapezoid from a planar view. The shape of the stopper body 410 from a planar view may indicate the shape when the stopper body 410 is projected onto a plane in an inserting direction of the stopper 400 of FIG. 8.

The stopper body 410 may be formed in a circular shape as illustrated in FIG. 10, example (a). The stopper body 410 may be formed in a curved polygonal shape as illustrated in FIG. 10, example (b). The stopper body 410 may be formed in a polygonal shape such as a pentagon as illustrated in FIG. 10, example (c). The stopper body 410 may be formed in a trapezoidal shape as illustrated in FIG. 10, example (d). However, the present disclosure is not limited thereto, and the stopper body 410 may have various shapes such as an oval or other shapes, as needed. The shape of the stopper body 410 is not particularly limited as long as the shape of the stopper body 410 is a shape capable of effectively sealing the injection port 210.

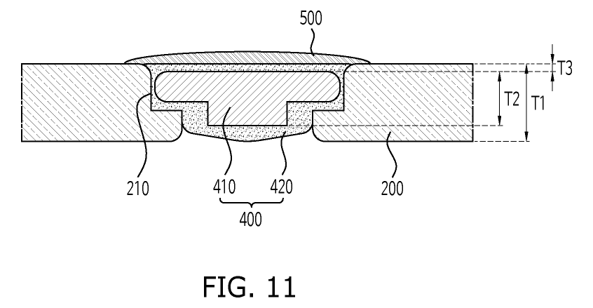

FIG. 11 is a cross-sectional view illustrating a secondary battery including a protective layer according to some embodiments of the present disclosure.

According to some embodiments, the case 200 may include stainless steel (SUS), and the secondary battery may be an SUS can-type secondary battery. A thickness T1 of the case 200 may be from about 50 μm to about 100 μm. A thickness T2 of the stopper body 410 may be less than the thickness T1 of the case 200. The stopper resin 420 may be coated on the outer circumferential surface of the stopper body 410 in a thickness T2 ranging from about 1 μm to about 10 μm.

An entire rigidity of the stopper 400 may be determined by the stopper body 410, and a sealing force of the stopper 400 to seal the electrolyte injection port 210 may be determined by the stopper resin 420. A thickness T2 of the stopper body 410 may be less than a thickness T1 of the case 200, so that the stopper 400 coupled to the electrolyte injection port 210 may not protrude outward from the case 200. The stopper resin 420 may be formed in a thickness T3 ranging from about 1 μm to about 10 μm and may be closely attached to the inner circumference of the electrolyte injection port 210 so as to not decrease the entire rigidity of the stopper 400, while also maintaining the sealing force.

A secondary battery may further include a protective layer 500 that covers the electrolyte injection port 210 in which the stopper 400 is placed. The protective layer 500 may cover a periphery of the partial area of the stopper 400 and the electrolyte injection port 210. The protective layer 500 may be formed by applying a UV (ultraviolet) curable resin to a portion of the stopper 400 and the injection port 210, and then curing the protective layer 500 using ultraviolet light. The protective layer 500 may cover the electrolyte injection port 210 where the stopper 400 is placed, thereby improving the bonding stability of the stopper 400 bonded by a pressing method.

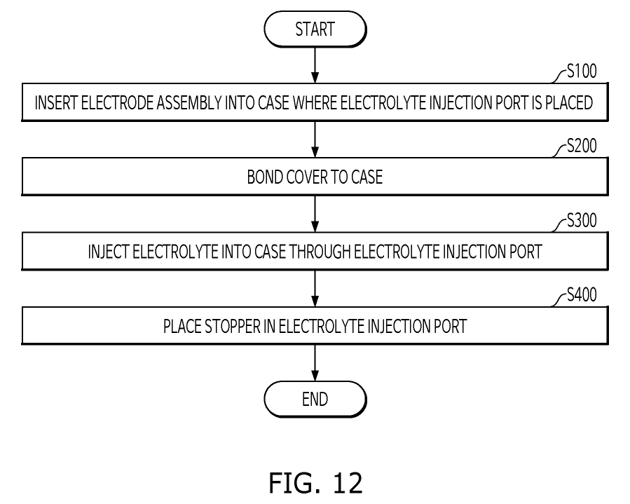

FIG. 12 is a flow chart illustrating a manufacturing process of a secondary battery according to some embodiments of the present disclosure.

According to some embodiments, a method of manufacturing a secondary battery may be initiated by inserting an electrode assembly in step S100. Referring to FIG. 12, a method of manufacturing a secondary battery may include inserting an electrode assembly in step S100, coupling a cover to a case in step S200, injecting an electrolyte into a case in step S300, and placing a stopper into an electrolyte injection port in step S400.

Inserting an electrode assembly, step S100, may include inserting an electrode assembly into one open surface of the case with an electrolyte injection port on a side surface of the case. After inserting an electrode assembly in step S100, coupling a cover to a case may be performed as step S200. Coupling a cover to a case in step S200 may include coupling a cover onto one open surface of the case.

When the coupling of the cover onto the case in step S200, the case may be bonded to the cover by metal bonding (e.g., welding, brazing, soldering, etc.) A flange of the case may be bonded to or near edges of the cover when coupling the cover to the case in step S200. A thickness of the case may be from about 50 μm to about 100 μm. The case and the cover are formed of a same metallic material, and the metallic material may include stainless steel.

After the attaching of the cover to the cover in step S200, injecting an electrolyte into a case may be performed as step S300. Injecting the electrolyte into the case in step S300 may include injecting an electrolyte into a case through an electrolyte injection port. After injecting the electrolyte into the case in step S300, sealing the secondary battery may be performed as step S400 by placing the stopper in the electrolyte injection port.

The placing of the stopper in the electrolyte injection port in step S400 may be placing a stopper including a resin material on an outer circumferential surface of an electrolyte injection port. The stopper may include a stopper body and a stopper resin coated on an outer circumferential surface of the stopper body.

After placing the stopper in the electrolyte injection port in step S400, the method may further include press-fitting the stopper in the electrolyte injection port by pressing one surface of the stopper. The stopper resin may be in contact or in close contact with the inner circumferential surface when press-fitting the stopper. When the stopper is placed and pressed in the electrolyte injection port, a stopper resin coated on the outer circumferential surface of the stopper body may be closely attached to the electrolyte injection port to prevent a space from forming between the stopper and the electrolyte injection port. Therefore, the electrolyte injection port may be sealed and the electrolyte inside the case may be prevented from leaking through the electrolyte injection port.

After placing a stopper in step S400, the method may further include forming a protective layer that covers an electrolyte injection port in which a stopper is arranged. The forming of the protective layer may include applying a UV curable resin to partial areas of the stopper and the electrolyte injection port and then irradiating ultraviolet light (UV light) to form a protective layer.

The flow chart of FIG. 12 and the above description are merely exemplary, and the present disclosure is not limited thereto. For example, one or more steps in the flow chart and the above description may be deleted, orders of one or more steps may be changed, one or more steps may be performed simultaneously, and/or one or more steps may be performed repeatedly multiple times.

Although the present disclosure has been described with reference to some embodiments and drawings illustrating aspects thereof, the present disclosure is not limited thereto. Various modifications and variations can be made by a person skilled in the art to which the present disclosure belongs.

### DESCRIPTION OF REPRESENTATIVE REFERENCE NUMERALS

10: Secondary Battery

100: Electrode Assembly

200: Case

210: Electrolyte Injection Port

300: Cover

400: Stopper

410: Stopper Body

420: Stopper Resin

500: Protective Layer

What is claimed is:

1. A secondary battery comprising:
an electrode assembly comprising a first electrode, a separator, and a second electrode;
a case comprising one open surface accommodating the electrode assembly and an electrolyte injection port on one side of the case;
a cover coupled to the one open surface of the case; and
a stopper comprising a resin material on an outer circumferential surface of the stopper, the stopper configured to seal the electrolyte injection port.

2. The secondary battery as claimed in claim 1, wherein the stopper comprises:
a stopper body; and
a stopper resin coated on an outer circumferential surface of the stopper body.

3. The secondary battery as claimed in claim 2, wherein the stopper is placed in the electrolyte injection port, and the stopper resin is in contact with an inner circumferential surface of the electrolyte injection port.

4. The secondary battery as claimed in claim 1, wherein the case and the cover are formed of a same metallic material.

5. The secondary battery as claimed in claim 4, wherein the same metallic material of the case and the cover comprises stainless use steel.

6. The secondary battery as claimed in claim 1, wherein a thickness of the case ranges from about 50 μm to about 100 μm.

7. The secondary battery as claimed in claim 2, wherein a thickness of the stopper body is less than a thickness of the case.

8. The secondary battery as claimed in claim 2, wherein the stopper body is formed in one of a circular, a polygonal, or a trapezoidal shape from a planar view.

9. The secondary battery as claimed in claim 2, wherein the stopper body has a spherical shape.

10. The secondary battery as claimed in claim 2, wherein the stopper body comprises at least one of stainless steel, aluminum, nickel, or iron.

11. The secondary battery as claimed in claim 2, wherein the stopper resin is a thermoplastic resin or a thermosetting resin.

12. The secondary battery as claimed in claim 2, wherein the stopper resin comprises at least one of polyimide, polyethylene terephthalate, polypropylene, polyethylene, polystyrene, acrylonitrile butadiene styrene copolymer, polyoxymethylene, polyvinyl chloride, polycarbonate, nylon, polycaprolactone, polylacticacid, acrylic resin, polyester, polybutylene terephthalate, celluloid, teflon, bakelite, epoxy, melamin, urea, and phenol.

13. The secondary battery as claimed in claim 2, wherein the stopper resin is coated on the outer circumferential surface of the stopper body, the stopper body having a thickness ranging from about 1 μm to about 10 μm.

14. The secondary battery as claimed in claim 1, further comprising a protective layer,
wherein the stopper is placed in the electrolyte injection port, and
wherein the protective layer is configured to cover the electrolyte injection port.

15. A method of manufacturing a secondary battery, the method comprising:
inserting an electrode assembly into one open surface of a case, the case having an electrolyte injection port on one side of the case;
attaching a cover onto the one open surface of the case;
injecting an electrolyte into the case through the electrolyte injection port; and
placing a stopper comprising a resin material onto an outer circumferential surface of the electrolyte injection port.

16. The method as claimed in claim 15, further comprising providing the stopper such that the stopper comprises:
a stopper body; and
a stopper resin coated on an outer circumferential surface of the stopper body.

17. The method as claimed in claim 16, further comprising press-fitting the stopper into the electrolyte injection port by pressing one surface of the stopper,
wherein the stopper resin is placed in contact with an inner circumferential surface of the electrolyte injection port.

18. The method as claimed in claim 15, further comprising providing the case such that a thickness of the case ranges from about 50 μm to about 100 μm.

19. The method as claimed in claim 15, further comprising providing the case and the cover such that the case and the cover are formed of a same metallic material, and the same metallic material comprises stainless use steel.

20. The method as claimed in claim 17, further comprising forming, after press-fitting the stopper into the electrolyte injection port, a protective layer that covers the electrolyte injection port.
